(19) United States
(12) Patent Application Publication
(10) Pub. No.: US 2015/0142608 A1
(43) Pub. Date: May 21, 2015

(54) SYSTEM AND METHOD FOR IDENTIFYING DOMAIN NAMES

(71) Applicants: ANDREW HORN, Seven Hills (AU); ADAM HUDSON, Beacon Hill (AU); GRAHAM JONES, Duramana (AU); MEAGAN TODD, North Sydney (AU); JOHN RICH, Vaucluse (AU)

(72) Inventors: ANDREW HORN, Seven Hills (AU); ADAM HUDSON, Beacon Hill (AU); GRAHAM JONES, Duramana (AU); MEAGAN TODD, North Sydney (AU); JOHN RICH, Vaucluse (AU)

(21) Appl. No.: 14/541,372

(22) Filed: Nov. 14, 2014

Related U.S. Application Data
(60) Provisional application No. 61/905,786, filed on Nov. 18, 2013.

(51) Int. Cl. G06Q 30/06

(52) U.S. Cl. CPC G06Q 30/0627; G06Q 30/0631
USPC 705/26.63

(57) ABSTRACT

Systems and methods for facilitating the identification and registration of available Internet domain names in response to user input and/or other external criteria. In embodiments, a domain name platform is provided for interfacing with a user, generating lists of available top level and second level domain combinations, and facilitating registration of those domains. In embodiments, information beyond user input may be considered in generating lists of available domain names. In alternate embodiments, a computer system is disclosed for implementing the system. In further embodiments, machine-usable storage media is disclosed containing instructions for implementing the system.

### CROSS-REFERENCE TO RELATED APPLICATION

This application claims benefit of priority of U.S. Provisional Application Ser. No. 61/905,786 titled, “SYSTEM AND METHOD FOR IDENTIFYING DOMAIN NAMES,” filed on Nov. 18, 2013, the contents of which is incorporated by reference herein in its entirety.

### FIELD

The present disclosure relates to systems and methods for facilitating the identification and registration of available Internet domain names in response to user input and/or other external criteria.

### SUMMARY OF THE INVENTION

In one version of the invention, a domain name platform is provided and access to said domain name platform over a network is enabled. A first user input is received by the domain name platform over the network, indicating characteristics of a top level or second level domain. The domain name platform then analyzes the first user input and incorporates the same into a first list of available domain name combinations, which list is sent to the user over the network. A user is able to select from within the first list to generate a second list of additional domain name combinations.

In one version of the invention, the domain name platform factors in information from the user's profile (e.g., system profile, social media, etc.) in generating the lists of available domain names. In yet another version of the invention, various permutations of the user input are incorporated into the results lists including, for example, synonyms to the user input, antonyms to the user input, and terms related to the user input in said first list of available domain names. In still further version of the invention, keywords may be provided to the user relative to the listings of available domain names, which keywords may be removable by the user to further refine the lists of available domain name combinations.

In one version of the invention, a user may be enabled to highlight available second level domains to receive a list of available related top level domains, or to highlight an available top level domain to receive a list of available related second level domains.

In embodiments of the invention, the domain name platform may enable the user to register a domain name combination from the list of available domain name combinations. In further embodiments, the domain name platform is configured to be accessible from a touch screen device.

In an embodiment of the invention, a computer system is provided for identifying domain names available for registration, the computer system comprising least one processing device, a network interface device, and a data storage device. The computer system further includes a set of instructions on the storage device, the set of instructions being readable by the processing device and including a user interface module for receiving user input from a client computing device connected to a network and said network interface device; domain name platform module for receiving a first user input indicating desired domain name characteristics, and generating a corresponding first list of available domain name combinations and transmitting said list over said network to said client computing device. In embodiments of the invention, the domain name platform module is further configured to receive a second user input through indicating a user selection of a top level domain or a second level domain from said first list, and use said second user input to generate a second list of available domain name combinations corresponding to said selected top level domain or second level domain.

In an embodiment of the invention a non-transitory machine-useable storage medium is provided, which embodies executable instructions. In embodiments, the instructions cause the machine to provide a domain name platform, enable access to the domain name platform by a client computing device over a network, receive a first user input through the domain name platform indicating desired domain name characteristics, generate a first list of available domain name combinations based upon said user input and transmit said list over the network to said client computing device, receive second user input through the domain name platform indicating a user selection of a top level domain or a second level domain from the first list; and use the second user input to generate a second list of available domain name combinations corresponding to the selected top level domain or second level domain.

### BRIEF DESCRIPTION OF THE DRAWINGS

The features and advantages of the disclosure will be more fully understood with reference to the following description of exemplary embodiments of the invention when taken in conjunction with the accompanying figures, which are a graphical representation of the salient elements of the present invention.

FIG. 1 illustrates an exemplary system architecture in accordance with one embodiment of the present disclosure.

FIG. 2 illustrates a GUI in accordance with a further embodiment of the present disclosure.

FIG. 3 illustrates a GUI in accordance with a further embodiment of the present disclosure.

FIG. 4 illustrates a GUI in accordance with a further embodiment of the present disclosure.

FIG. 5 illustrates a method of purchasing a domain name according to embodiments of the present disclosure.

FIG. 6 illustrates an exemplary computing device within which a set of instructions, for causing the machine to perform any one or more of the methodologies discussed herein, may be executed.

### DESCRIPTION

Mechanisms for identifying domain names and/or purchasing domain names are described. A domain name (e.g., “domain.com”) may be an identifier (e.g., a string, an alphanumeric value, etc.) that defines a realm of administrative autonomy, authority, or control on the Internet. Domain names may be formed according to the rules and/or procedures of the Domain Name System (DNS). Domain names may be organized into different levels or subdomains of the DNS root domain. The first-level set of domain names may be referred to as the top-level domains (TLDs). TLDs may generic top-level domains (gTLDs), such as the domains “com,” “net,” “edu,” and “org.” TLDs may also include country code top-level domains (ccTLDs). Below the TLDs are second-level domain names (SLDs) and/or third-level domain names that may be reserved by users who wish to connect other networks to the Internet and/or make other resources available or accessible via the Internet (e.g., web sites or web pages).

In one embodiment, a domain name platform may receive user input indicating a TLD and/or an SLD that the user may wish to purchase. The domain name platform may receive the user input and may present data indicating which TLDs and/or SLDs are available to the user. For example, if the user input indicates an SLD, the domain name platform may present a list of TLDs that are available with the SLD. In another example, if the user input indicates a TLD, the domain name platform may present a list of TLDs that are available with the SLD. The domain name platform may also provide suggested TLDs and/or SLDs to a user. The domain name platform may further allow a user purchase an SLD and/or TLD.

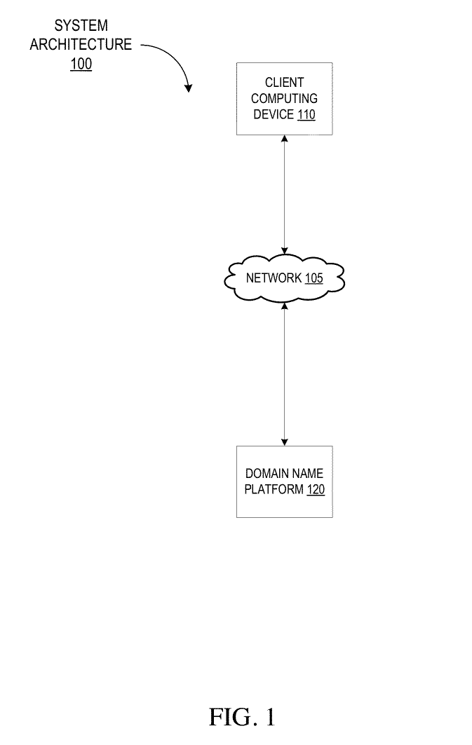

Referring to FIG. 1, the system architecture 100 includes a client computing device 110, a network 105, and a domain name platform 120. In one embodiment, network 105 may include one or more of a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. The client computing device 110 may be a computing device such as a personal computer (PC), a laptop computer, a mobile phone, a smart phone, a cellular phone, a personal digital assistant (PDA), a tablet computer, a netbook computer, a smartwatch, a rackmount server, a router computer, a server computer, a mainframe computer, a desktop computer, etc.

In one embodiment, the domain name platform 120 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that allow users to identify different domains and/or domain names (e.g., top-level domains and/or second level domains) that are available and to purchase different domains and/or domain names. For example, the domain name platform 120 may receive requests to view available domain names. For example, the domain name platform 120 may receive user input from a user identifying a TLD and/or an SLD. The domain name platform 120 may present data indicating whether a TLD and/or an SLD are available for purchase and may provide data indicating additional TLDs and/or SLDs that the may be interested in.

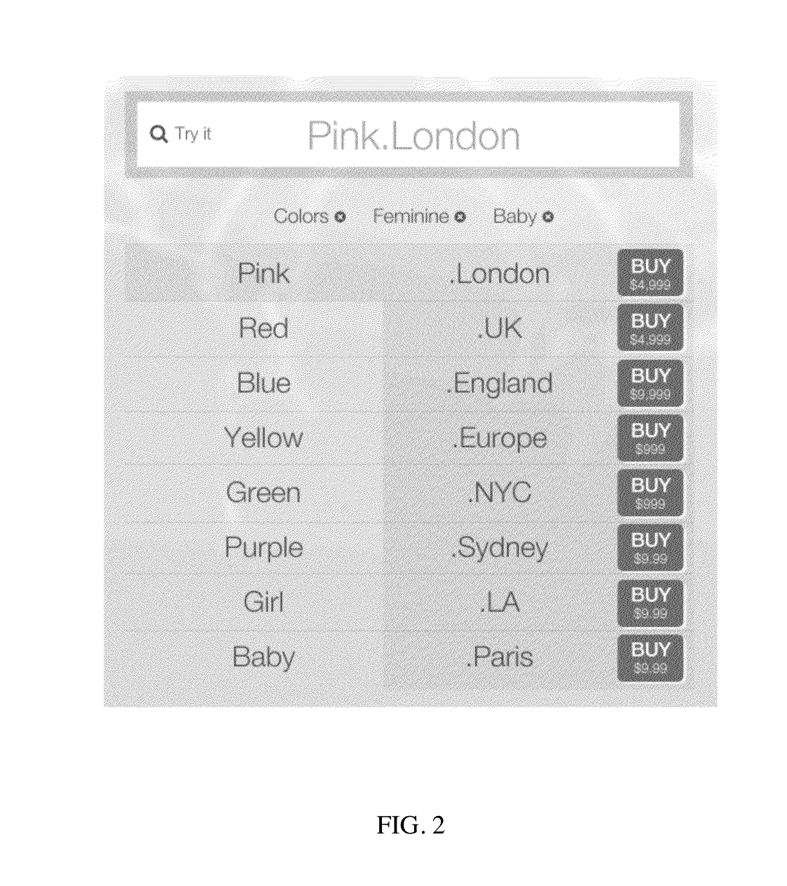

In one embodiment, the domain name platform 120 may provide a web page and/or a web site that a user may access using a browser application (e.g., a web browser) on the client computing device 110. The domain name platform 120 may provide graphical user interfaces (GUIs) via the web page (as discussed below in conjunction with FIGS. 2-4) and the GUIs may be rendered by the browser application (not shown in the figures) on the client computing device 110. The user may provide user input (e.g., type in the name of a TLD and/or SLD, select a TLD and/or SLD displayed on the GUI) using the web browser and the domain name platform 120 may receive the user input and present data indicating whether a TLD and/or SLD is available, present data indicating additional TLDs and/or SLDs a user may be interested in, etc. In another embodiment, the client computing device 110 may include an application, software module, etc., that may communicate with the domain name platform 120. The application may present the GUIs discussed below in conjunction with FIGS. 2-4. The domain name platform 120 may receive data from the client computing devices (e.g., data indicating TLDs and/or SLDs, data indicating a request to purchase a TLD and/or SLD) and the domain name platform 120 may provide data indicating which TLDs and SLDs are available and/or data indicating additional TLDs or SLDs.

In one embodiment, the domain name platform 120 may also be a domain name registrar. A domain name registrar may be an organization that manages the reservation of Internet domain names. A domain name registrar may allow users to purchase TLDs and/or SLDs. The user may purchase a TLD and/or an SLD from the domain name platform 120. In another embodiment, the domain name platform 120 may communicate with a separate domain name registrar to determine whether a TLD and/or and SLDs are available and may allow the user to purchase the TLD and/or SLD using the domain name registrar (via the domain name platform 120).

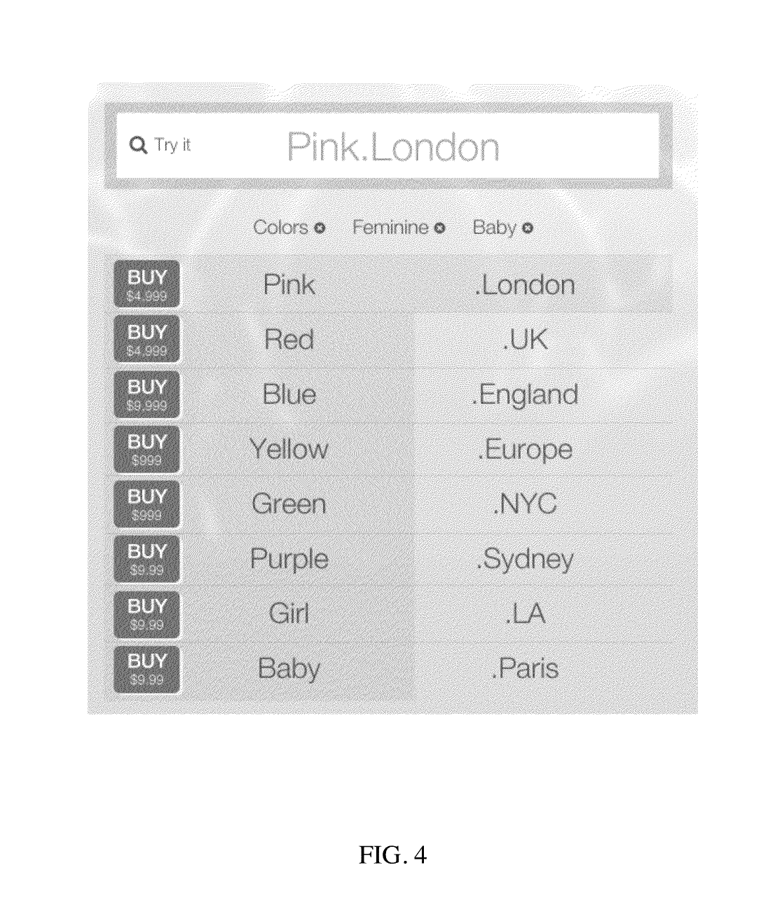

Referring to FIG. 2, the GUI may be presented to the user by browser application and/or other application/software module. As discussed above, a user may provide user input indicating a TLD and/or SLD. As illustrated in FIG. 4, the user has provided user input indicating “Pink.London” in a search bar at the top of the GUI, where “Pink” is an SLD and “London” is a TLD. In one embodiment, the user may not provide both the TLD and SLD. For example, if the user provided the SLD “Pink,” The domain name platform may provide the same list of TLDs in a results section (e.g., the right hand column) illustrated in FIG. 2 (e.g., London, UK, England, Europe, NYC, Sydney, La., Paris, etc.). The domain name platform may provide the list of TLDs based on the user's social interactions and/or social communities (e.g., based on whether the user is connected to Twitter, Facebook, LinkedIn, etc.). For example, a user's Facebook profile may indicate that the user is located in Europe and the domain name platform may identify TLDs that are associated with Europe. The domain name platform may also provide the list of TLDs based on popularity of the TLD with other user. For example, “.com” and “.net” may be popular TLDs that are selected or used by other users and the domain name platform may display TLDs in the list starting from the most popular TLD at the top of the list to the least popular TLD on the bottom of the lists.

In another embodiment, the domain name platform may analyze the SLD provided by the user and may suggest other SLDs that may be related to and/or associated with the SLD provided by the user. The suggested SLDs may also be of interest to the user because they are associated with and/or related to the SLD provided by the user. For example, the SLD “Green” is related to the SLD “Pink” (provided by the user) because both the SLDs are related to colors. The domain name platform may also identify and/or present tags that related to the SLD. For example, as illustrated in FIG. 2, the SLDS “Pink” correlates to Colors, Feminine and Baby related words. The tags “Colors,” “Feminine,” and “Baby” are presented in the GUI. The suggested SLDs may be presented in an order based on how many of the tags fit the suggested SLDs. For example, SLDs that fit all three tags are higher in the list, then SLDs that fit two tags are lower in the list and finally SLDs that fit one of the tags are last in the list.

In one embodiment, the user may remove tags that the user may not find relevant. For example, if the user was interested in the tag “Colors” and not interested in the tags “Feminine” or “Baby,” the user can remove the “Feminine” and “Baby” tags by selected and/or activating the “X” icon or button next to the tags. The list of SLDs may be changed and/or re-ordered when the user deselects one or more tags.

As illustrated in FIG. 1, the SLD/TLD Pink.London is available (e.g., other users have not yet purchased or reserved the SLD/TLD) and is presented at the top of the list. The GUI also highlights different TLDs that may also be available (e.g., UK, England, Europe, NYC, etc.), with the selected SLD (e.g., “Pink”) and presents a buy button next to each of the TLDs. The buy button may also indicate the price for purchasing the SLD/TLD. For example, Pink.London will cost $4,999 and Pink.England will cost $9,999. When the user activates a buy button, the domain name platform may provide another GUI that allows the user to enter payment information and purchase the desired TLD and/or SLD.

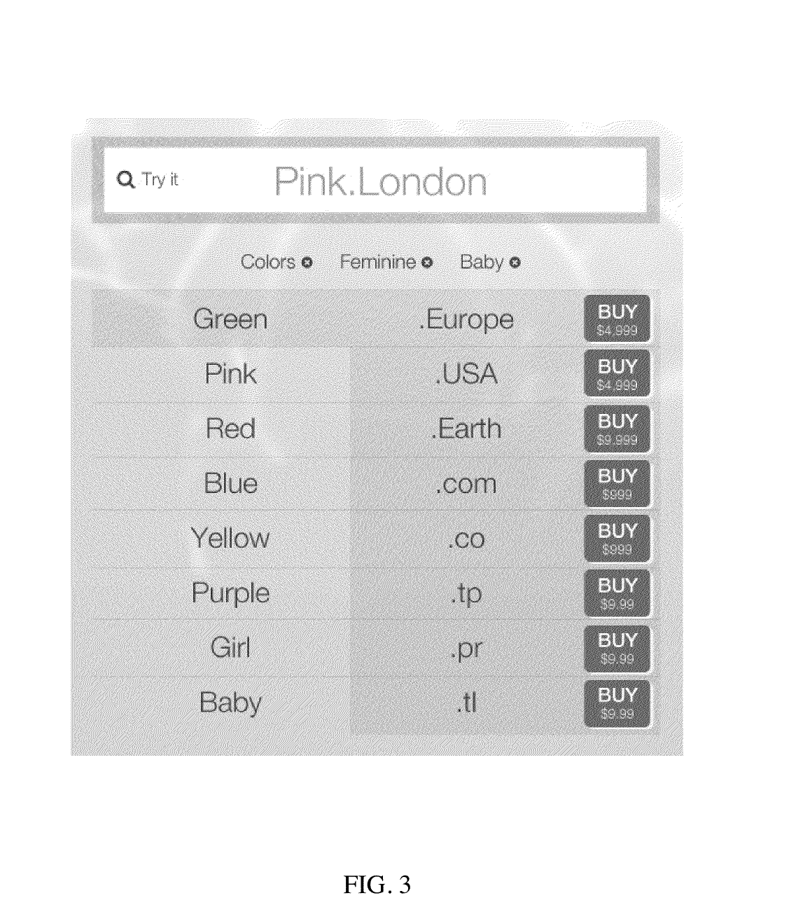

Referring to FIG. 3, the GUI may be presented to the user by browser application and/or other application/software module. As discussed above, a user may provide user input indicating a TLD and/or SLD and domain name platform may provide data indicating whether the TLD and/or SLD are available for purchase. The domain name platform may also provide different TLDs and/or SLDs that the user may be interested in (e.g., the domain name platform may suggest different TLDs and/or SLDs).

As illustrated in FIG. 3, the user may select one of the suggested SLDs. For example, the GUI illustrated in FIG. 3 may be presented after the user selects the SLD “Green” from the list of SLDs (e.g., Pink, Red, Blue, Yellow, Green, Purple, etc.) presented in FIG. 2. The user may also select another SLD in the list of SLDs illustrated in FIG. 3 and the domain name platform may present data indicating the TLDs that are available with the selected SLD in a results section (e.g., the right hand column).

As illustrated in FIG. 3, the user has selected the SLD “Green.” The selected SLD (e.g., Green) is presented at the top of the list of SLDs because the user has selected the SLD. For example, as illustrated in FIG. 2, the SLD Green was fifth from the top of the list of SLDs. After the user selects the SLD green, the SLD is displayed at the top of the list, as illustrated in FIG. 3. The TLDs that available with the SLD “Green” presented in the list of TLDs (e.g., Europe, USA, Earth, com, co, tp, pr, tl) in the right column. The GUI also presents a buy button next to each of the TLDs. The buy button may also indicate the price for purchasing the SLD/TLD. For example, Green.Europe will cost $4,999 and Green.Earth will cost $9,999. When the user activates a buy button, the domain name platform may provide another GUI that allows the user to enter payment information and purchase the desired TLD and/or SLD or the domain name platform may add the selected SLD and/or TLD to the user's shopping cart.

In one embodiment, the original search terms (e.g., Pink.London) and the tags (e.g., Colors, Feminine, Baby) are presented in the GUI even though the user has selected one or more of the SLDs and TLDs suggested by the domain name platform. In another embodiment, the search terms and/or tags may not change until the user performs a new search in the search bar.

Referring to FIG. 4, the GUI may be presented to the user by browser application and/or other application/software module. As discussed above, a user may provide user input indicating a TLD and/or SLD and domain name platform may provide data indicating whether the TLD and/or SLD are available for purchase. The domain name platform may also provide different TLDs and/or SLDs that the user may be interested in (e.g., the domain name platform may suggest different TLDs and/or SLDs).

In one embodiment, the user may select a TLD from the list of TLDs. For example, with new TLDs (e.g., new gTLDs such as London, Paris, etc.), users may wish to obtain a domain name with a specific TLD. For example, if the user has a store in London, the user may select the TLD London. In one embodiment, when the user selects a TLD, the domain name platform may provide data indicating a list of SLDs that are available with the TLD, as opposed to providing a list of TLDs that are available with a selected SLD (as illustrated in FIGS. 2 and 3).

As illustrated in FIG. 4, the user has selected the TLD. When the user selects the TLD “London” the results section may flip or may reverse (when compared to the result sections illustrated in FIGS. 2 and 3). For example, the results section may be the left hand column when the user selects a TLD). The selected TLD (e.g., London) is displayed at the top of the right hand column (which includes a list of TLDs). The domain name platform may identify SLDs that that user may be interested in and may display the suggested SLDs that are available with the TLD “London” if the left had column (e.g., in a different results section).

In one embodiment, the GUI also presents a buy button next to each of the SLDs in the results section (e.g., in the left-hand side of the GUI). The buy button may also indicate the price for purchasing the SLD/TLD. For example, Pink.London will cost $4,999 and Pink.Girl will cost $9.99. When the user activates a buy button, the domain name platform may provide another GUI that allows the user to enter payment information and purchase the desired TLD and/or SLD or the domain name platform may add the selected SLD and/or TLD to the user's shopping cart.

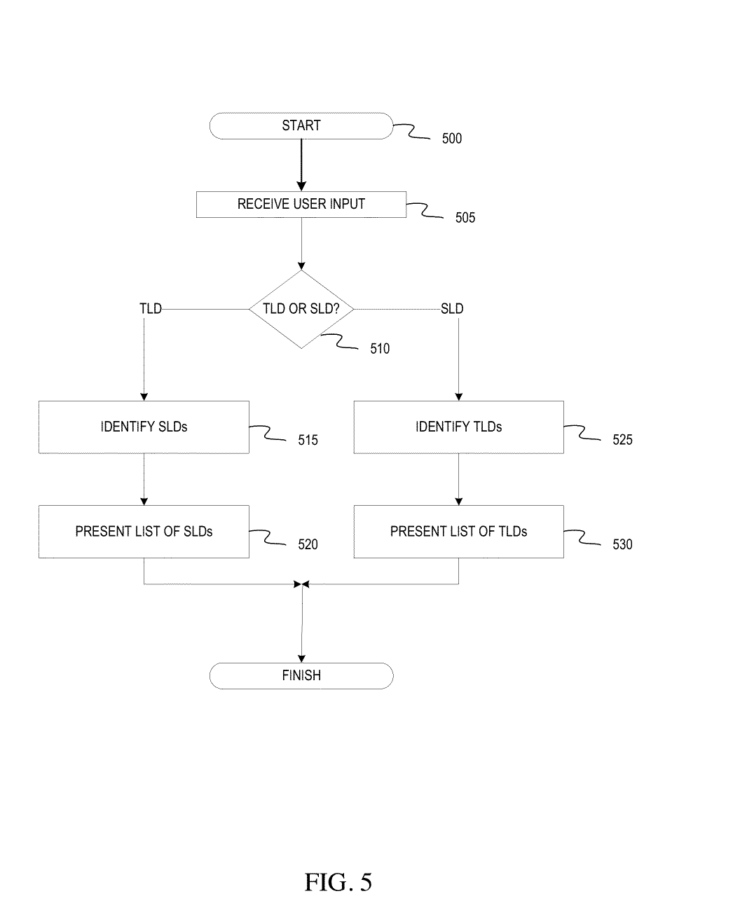

Referring to FIG. 5, a flow diagram illustrating a method 500 of purchasing a domain name is shown. For simplicity of explanation, the method is depicted and described as a series of acts. However, acts in accordance with this disclosure can occur in various orders and/or concurrently and with other acts not presented and described herein. Furthermore, not all illustrated acts may be required to implement the methods in accordance with the disclosed subject matter. In addition, those skilled in the art will understand and appreciate that the methods described herein could alternatively be represented as a series of interrelated states via a state diagram or events. The method 500 may be performed by processing logic that comprises hardware (e.g., circuitry, dedicated logic, programmable logic, microcode, etc.), software (e.g., instructions run on a processor to perform hardware simulation), or a combination thereof. In one embodiment, method 500 may be performed by a domain name platform, as illustrated in FIG. 1.

Referring to FIG. 5, the method 500 begins at block 505 where the processing logic receives user input from a browser application and/or other application (e.g., a standalone application). At block 510, the processing logic determines whether the user input indicates a selection of a TLD or an SLD. If the user input indicates a selection of a TLD, the processing logic may identify one or more SLDs at block 515. For example, the processing logic may identify SLDs that are related to an SLD that was provided by the user. At block 520, the processing logic provides the list of SLDs to the user (e.g., via a GUI). After block 520, the method 500 ends. Referring back to block 510, if the user input indicates a selection of an SLD, the processing logic may identify one or more TLDs at block 525. For example, the processing logic may identify TLDs that are related to a TLD that was provided by the user. At block 530, the processing logic provides the list of TLDs to the user (e.g., via a GUI). After block 530, the method 500 ends.

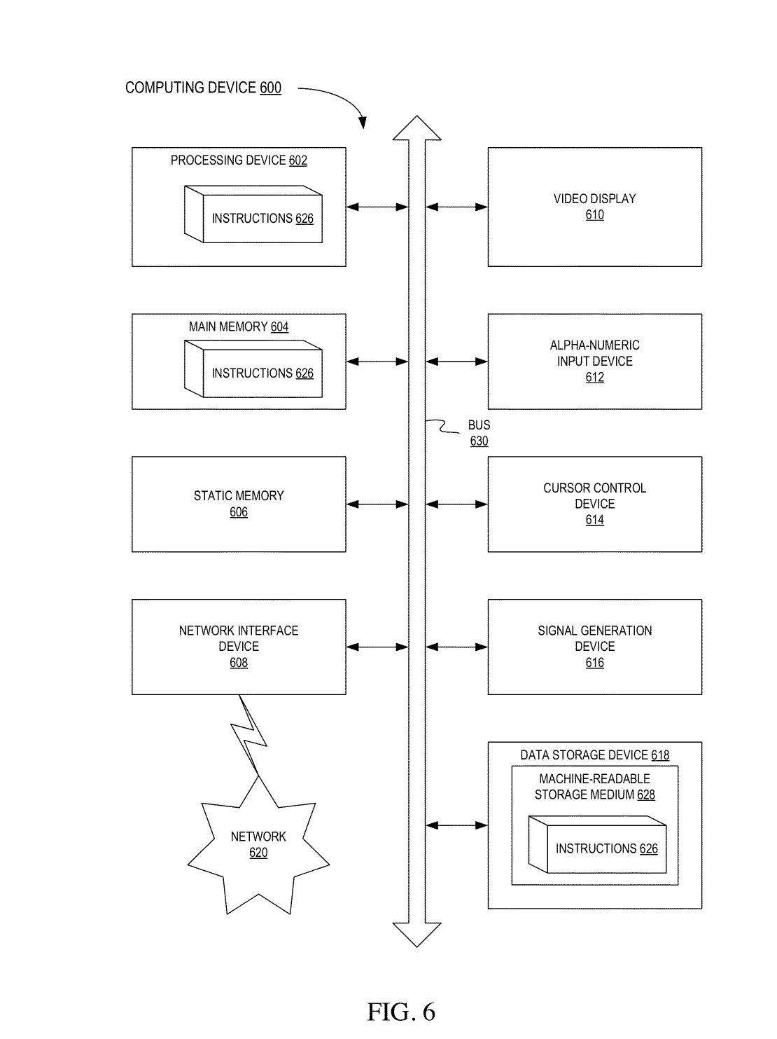

Referring to FIG. 6, a computing device 600 may be a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, the computing device 600 may execute a domain name platform (as illustrated in FIG. 1).

The example computing device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 618, which communicate with each other via a bus 630.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and a signal generation device 616 (e.g., a speaker). In one embodiment, the video display unit 610, the alphanumeric input device 612, and the cursor control device 614 may be combined into a single component or device (e.g., an LCD touch screen).

The data storage device 618 may include a computer-readable storage medium 628 on which is stored one or more sets of instructions 626 embodying any one or more of the methodologies or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 620 via the network interface device 608.

While the computer-readable storage medium 628 is shown in an example embodiment to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media and magnetic media.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying,” “subscribing,” “providing,” “determining,” “unsubscribing,” “receiving,” “generating,” “changing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

We claim:

1. A method for identifying available domain names for registration, comprising:
a. providing a domain name platform;
b. enabling access to said domain name platform by a client computing device over a network;
c. receiving a first user input through said domain name platform indicating desired domain name characteristics;
d. generating a first list of available domain name combinations based upon said first user input and transmitting said list over said network to said client computing device;
e. receiving second user input through said domain name platform indicating a user selection of a top level domain or a second level domain from said first list; and
f. using said second user input to generate a second list of available domain name combinations corresponding to said selected top level domain or second level domain.

2. The method of claim 1 where step of generating a first list of available domain name combinations factors in information from the user's profile.

3. The method of claim 1 wherein said step of generating a first list of available domain name combinations includes including one of synonyms to the user input, antonyms to the user input, and terms related to the user input in said first list of available domain names.

4. The method of claim 1 wherein said domain name platform generates keywords associated with the user input, said keywords being optionally removable by the user to further refine said first or second lists.

5. The method of claim 1 in which said domain name platform enables the user to highlight available second level domains to receive a list of available related top level domains.

6. The method of claim 1 in which said domain name platform enables the user to highlight an available top level domain to receive a list of available related second level domains.

7. The method of claim 1 in which said domain name platform enables the user to register a domain name combination from said mobile computing device.

8. The method of claim 1 wherein said mobile computing device incorporates a t′ screen and said domain name platform domain name is further configured to received input generated on said touch screen.

9. A computer system for identifying domain names available for registration, comprising:
a. least one processing device;
b. a network interface device;
c. a data storage device;
d. a set of instructions on the storage device, the set of instructions being readable by the processing device and including:
e. a user interface module for receiving user input from a client computing device connected to a network and said network interface device;
f. a domain name platform module for receiving a first user input indicating desired domain name characteristics, and generating a corresponding first list of available domain name combinations and transmitting said list over said network to said client computing device;
g. wherein said domain name platform module is further configured to receive a second user input through indicating a user selection of a top level domain or a second level domain from said first list, and use said second user input to generate a second list of available domain name combinations corresponding to said selected top level domain or second level domain.

10. The system of claim 9 wherein said domain name platform is further configured incorporate information from the user's profile when generating said first list of available domain name combinations.

11. The system of claim 9 wherein said first list of available domain name combinations includes one of synonyms to the user input, antonyms to the user input, and terms related to the user input.

12. The system of claim 9 wherein said domain name platform module generates keywords associated with the user input, said keywords being optionally removable by the user to further refine said first or second lists

13. The system of claim 10 in which said domain name platform module enables the user to highlight available second level domains to receive a list of available related top level domains.

14. The system of claim 10 in which said domain name platform module enables the user to highlight an available top level domain to receive a list of available related second level domains.

15. The system of claim 10 wherein said domain name platform module is configured to process input from a mobile computing device that incorporates a touch screen.

16. A non-transitory machine-useable storage medium embodying instructions which, when executed by a machine, cause the machine to:
a. provide a domain name platform;
b. enable access to said domain name platform by a client computing device over a network;
c. receive a first user input through said domain name platform indicating desired domain name characteristics;
d. generate a first list of available domain name combinations based upon said user input and transmit said list over said network to said client computing device;
e. receive second user input through said domain name platform indicating a user selection of a top level domain or a second level domain from said first list; and
f. use said second user input to generate a second list of available domain name combinations corresponding to said selected top level domain or second level domain.

17. The machine-useable storage medium of claim 16 containing further instructions which, when executed by said machine, cause said machine to incorporate additional criteria beyond domain name availability in generating said first or second lists.
